(19) United States
(12) Patent Application Publication
(10) Pub. No.: US 2025/0124259 A1
(43) Pub. Date: Apr. 17, 2025

(54) EXTRACTING ACTIONABLE SELF-EXPLANATIONS FROM VARIATIONAL AUTOENCODER LATENT SPACE IN USER AND ENTITY BEHAVIOR ANOMALY DETECTION

(71) Applicant: Dell Products L.P., Round Rock, TX (US)

(72) Inventors: Adriana Bechara Prado, Niterói (BR); Alexander Eulalio Robles Robles, Valinhos (BR); Eduarda Tatiane Caetano Chagas, Belo Horizonte (BR); Isabella Costa Maia, São Paulo (BR); Karen Stéfany Martins, Belo Horizonte (BR)

(21) Appl. No.: 18/487,923

(22) Filed: Oct. 16, 2023

(51) Int. Cl. G06N 3/0455

(52) U.S. Cl. CPC G06N 3/0455

(57) ABSTRACT

A framework for extracting actionable explanations using a VAE model. The VAE model operates on a test set of non-anomalous samples. Reconstruction errors are computed based on the VAE's output. The reconstruction errors are used to define a threshold that is usable to determine whether data is anomalous or is non-anomalous. A set of synthetic samples are generated by navigating through a latent space that exists between embeddings of anomalous input and embeddings of anomalous denoised samples. Differences between the synthetic samples and their neighbors are computed. These differences are used to generate a temporal heatmap.

### FIELD OF THE INVENTION

Embodiments of the present invention generally relate to performing anomaly detection. More particularly, at least some embodiments of the invention relate to systems, hardware, software, computer-readable media, and methods for extracting actionable self-explanations from variational autoencoder latent space.

### BACKGROUND

Zero trust is a network security paradigm based on the philosophy that an enterprise should never trust users or devices inside or outside the network, thus creating a policy of continuous authentication and traffic log analysis. With the emergence of this paradigm, it has become desirable to explore techniques that focus on learning patterns that distinguish between “good” and “non-good” behavior. To make the analysis and investigation of anomalous signals efficient, it is beneficial to understand the factors that characterize a normal user behavior in a system.

In line with the efficient anomaly identification, it is also beneficial to understand what influenced the model choices and which sample elements characterized a behavior as suspicious. Understanding the reasons why a deep learning model made its decisions has been one of the biggest challenges of artificial intelligence in recent years. Due to the lack of formalization in the definition of explainability, not all explanations focus on providing possible decision-making options to the user.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 illustrates an example architecture for extracting actionable explanations.

FIG. 2 illustrates various phases for performing the extraction.

FIG. 3 illustrates steps to train a variational autoencoder (VAE).

FIG. 4 illustrates steps to define an anomaly threshold.

FIG. 5 illustrates how to generate synthetic samples.

FIG. 6 illustrates how to construct a visualization of explanations.

FIG. 7 illustrates the latent space of a VAE.

FIGS. 8A and 8B illustrate the various phases.

FIG. 9 illustrates a heatmap and a set of counterfactual examples.

FIG. 10 illustrates a flowchart of an example method for extracting actionable explanations.

FIG. 11 illustrates an example computer system that can be configured to perform any of the disclosed operations.

### DETAILED DESCRIPTION OF SOME EXAMPLE EMBODIMENTS

As used herein, the phrase “actionable explanation” refers to an explanation that provides possible decision-making operations to a user. Examples of techniques that provide actionable explanations are “counterfactual algorithms.” By way of example, the counterfactual explanation of a prediction would describe what the smallest delta would be required in order to change a prediction into a predefined or predetermined output.

Because counterfactual algorithms provide post-hoc explanations, this class of algorithm needs to know in advance that a given behavior is anomalous in order to provide synthetic samples of acceptable patterns. Doing so, however, increases the computational cost.

Concurrently, due to the nature of the anomaly detection problem, events considered “non-good” are expected to occur less frequently than “known good” events. In addition to this natural imbalance, it is often quite difficult and involved to label large datasets, which makes the use of unsupervised machine learning models preferable.

In this context, variational autoencoder (VAE) algorithms present a workable solution to some of the previously-described problems. VAEs are valuable because unsupervised models do not need labels to be trained. VAEs also have valuable denoising characteristics. To illustrate, once trained, such models can build a non-anomalous synthetic sample very close to the anomalous sample given as input, with the difference between the input and the output being within an acceptability threshold. VAEs also provide a regular latent space with associated semantics (e.g., close points in the latent space will produce similar synthetic samples when decoded).

However, in terms of explainability, VAEs typically provide two types of explanations in the literature. Once explanation involves characteristics that distinguish the anomalous input from the non-anomalous. Another characteristic involves behavior patterns previously learned by the model.

Aiming to improve the explainability potential of this technique, the disclosed embodiments use the latent space generated by a VAE to provide actionable explanations with properties similar to counterfactual synthetic samples. More specifically, the disclosed embodiments address and resolve a number of problems.

One problem involves the absence of methods that provide an end-to-end approach to producing actionable explanations. For example, current proposals do not provide actionable explanations for the user. That is, traditional proposals require the use of a specific algorithm for this function, thereby increasing the computational cost and the mean-time issue identification.

Another problem deals with the issue of how to increase the VAE model's interpretability. For instance, traditional explanations extracted from VAEs do not use the self-model to construct a visual actionable explainability tool. In addition, most proposals focus on searching for similar patterns among a database of samples previously observed by the model.

The disclosed embodiments provide numerous benefits, advantages, and practical applications in the technical field of anomaly detection, mitigation, and actionable explanations. Traditional methodologies for providing actionable explanations applied post-hoc explainability techniques. That is, the traditional process was partitioned into two steps, namely: (i) anomaly detection, where specific techniques were performed and (ii) generation of actionable explanations, where model-agnostic explanation generation methods were applied. The embodiments beneficially provide a framework to detect collective anomalies and to generate actionable explanations. By implementing the disclosed principles, the embodiments significantly reduce the computational cost associated with post-hoc explainability operations.

The disclosed embodiments also beneficially provide visual actionable explanations. For instance, the embodiments are able to combine the learned knowledge about “good” patterns gained throughout the VAE model training with the ability to sample new data from the regular latent space.

The disclosed embodiments also generate new samples between the anomaly and non-anomaly subspace, thereby increasing the VAE model's interpretability. That is, with the use of these samples, the embodiments are beneficially able to compute a heatmap that will help the user to visualize the main patterns used by the model to identify an anomaly or “non-good” behavior. Accordingly, these and numerous other benefits will now be described in more detail throughout the remaining portions of this disclosure.

### Collective Anomalies

Anomalies can be categorized into three major groups, namely: point, collective, and contextual anomalies. The disclosed embodiments generally perform operations to address the second group (i.e., collective anomalies). These types of anomalies correspond to anomalies present in a set of data instances. Considering the zero-trust context, the embodiments are able to analyze scenarios involving malicious actions over a specific period of time. Such types of anomalies are also referred to as “discords.”

### Variational Autoencoder

In the context of neural network anomaly detection, autoencoders are quite popular. By compressing the input into a low dimensional space, these encoders are able to learn fundamental characteristics for a representation. Thus, from reconstruction errors obtained by measuring the divergence between the input and output of the network, it is possible to obtain a suspicious behavior indicator.

For the denoising process, a network can be trained using non-anomalous data. When receiving anomalous data in a so-called “inference” process, the network will be trained to provide the reconstruction of a cleaned input version as output.

However, what makes such types of variational autoencoder architectures different is the latent regular space. This latent space has inherent semantics and provides these architectures with the ability to generate new instances that appear to have been sampled from the training set. For this, the codification is sampled from a normal distribution.

### Counterfactual Ensemble Explanations

Ensembles of counterfactual examples have recently emerged as a new approach on visualizing explanations, thereby enriching the process of understanding the internal inference mechanism of a given machine learning model. This type of explanation uses information from counterfactual examples, either individually or as a whole, to understand the boundaries learned throughout the training process. It is desirable to seek ways to effectively communicate more complex explanations to users.

### Example Architectures

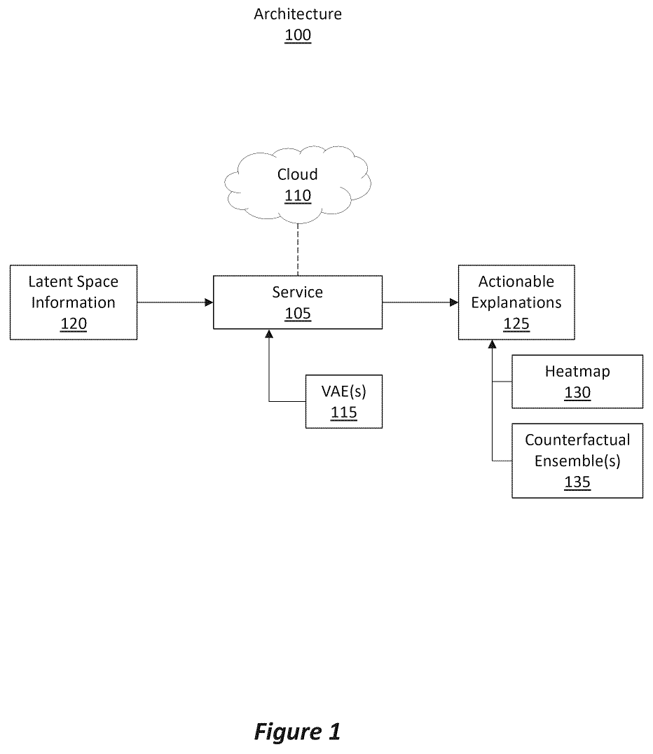

Having just provided some supplemental information and details regarding some of the benefits provided by the disclosed embodiments, attention will now be directed to FIG. 1. FIG. 1 shows an example architecture 100 that includes a service 105. As used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine. The ML engine enables service 105 to operate even when faced with a randomization factor.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud environment 110. In some implementations, service 105 is a local service operating on a local device. In some implementations, service 105 is a hybrid service that includes a cloud component operating in the cloud and a local component operating on a local device. These two components can communicate with one another.

Service 105 is generally tasked with increasing the interpretability of VAE models in collective anomaly detection tasks. For instance, as shown, service 105 may include or may be associated with VAE(s) 115.

Service 105 uses previously trained latent space information 120 from a VAE to provide actionable explanations 125 through a heatmap 130 and counterfactual ensemble(s) 135. In this heatmap, service 105 is able to highlight the main changes applied to the input to remove the patterns considered suspicious by the model (e.g., the VAE model, or VAE(s) 115). From the counterfactual ensembles, service 105 is able to highlight possible actionable changes that can be used to transform an anomalous event into a non-suspicious or unsuspicious event. The procedures for generating actionable explanations from VAE models are executed in three phases.

Phase one involves accessing a previously trained VAE model for time series reconstruction. Phase one can be sub-divided into the following steps.

One step involves starting with a test set composed of N non-anomalous time series containing a set of F features and T timestamps. Service 105 obtains the output of the VAE for each time series (i.e., its reconstruction by the model) and computes a measure of reconstruction error using, for example, mean square error (MSE).

Based on the N reconstruction errors obtained, service 105 sets a threshold r. If the reconstruction error is greater than r, service 105 considers the series anomalous. Otherwise, the series will not exhibit any suspicious behavior.

Phase two involves a time series X reconstructed by the VAE with a reconstruction error e>r, i.e., an anomalous sequence. Phase two can be sub-divided into the following steps.

One step involves service 105 obtaining the representation of Z_{X} and X in the latent space of the VAE. For example, let X′ be the sequence obtained after the X reconstruction by the VAE. Service 105 will compute the representation of Z_{X′} in latent space. Let N be the number of steps described in the explanation, and N will be a hyperparameter. There will be N intermediate values between Z_{X} and Z_{X′}.

For each i (1≤i≤N), service 105 (i) takes a new step towards Z_{X′}; (ii) obtains Xᵢ by decoding this new sample; and (iii) stores Xᵢ in a sequence list L. If the reconstruction error of Xᵢ in relation to X is greater than r, service 105 will store the value in G_{denoised} list. Service 105 will also add, at the beginning and end of the list L, the sequencies X and Xₜ respectively.

Regarding phase three, in the list L obtained in phase two, service 105 has N+2 multivariate time series with |F|×|T| dimension, where N will be the total number of synthetic sequencies generated in the latent space. So, using L, service 105 will calculate the difference values between a sequence Xᵢ and its consecutive X₍ᵢ₊₁₎, and service 105 will store it in a new list H. From the N+1 sequences of differences present in this new list H, service 105 will obtain the heatmap of alterations. The dimension of the heatmap will be |F|×|T|×(N+1). With this plot, service 105 will provide to the user what changes are necessary for the model to build “good” behavior from a sample previously characterized as anomalous.

The above description provided some high level details regarding the operations of the disclosed embodiments. The following sections will provide further details regarding the different phases.

### Further Details

As mentioned above, the disclosed embodiments present a framework to extract self and actionable explanations using VAE models. Beneficially, the embodiments can provide the user what changes must be made to the anomalous sample to be considered as “good” by the model. By using the VAE latent space to assist the user in understanding the process of the anomaly's roots, the embodiments are able to tackle the gaps in the traditional techniques. In particular, by exploring the use of the VAE latent space, the embodiments beneficially reduce the cost and response time associated with the post-hoc explainability step (as counterfactual explanations). The embodiments also beneficially provide a heatmap and a counterfactual ensemble to highlight the patterns considered suspicious in the sample.

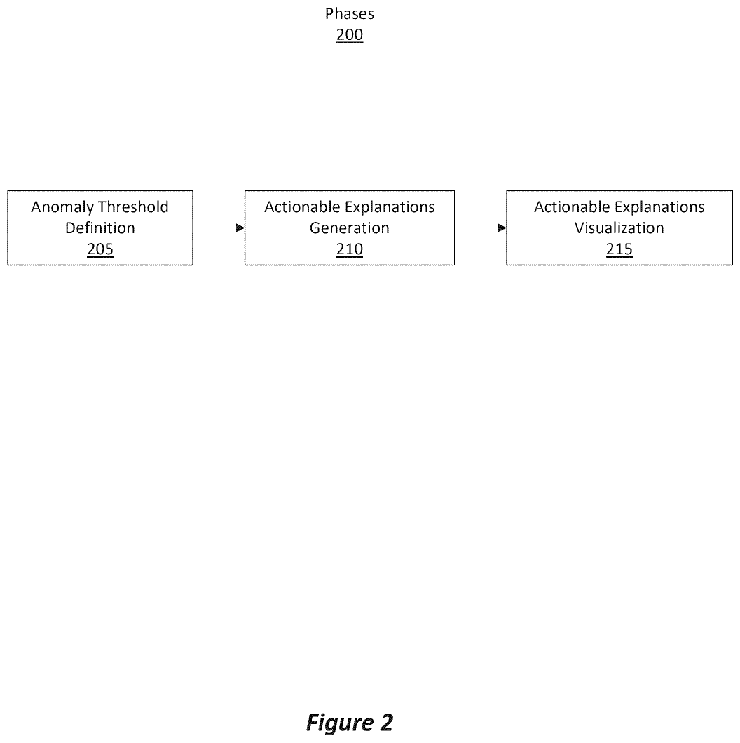

The disclosed principles propose the inclusion of two new operations, executed after the detection of a new anomaly by the previously trained VAE model. These operations include: (i) construction of the synthetic samples (phase two) and (ii) visualization of the explanations (phase three). FIG. 2 depicts the overview of the framework, which is divided into three main phases 200. Phase one includes the anomaly threshold definition 205. Phase two includes the actionable explanations generation 210. Phase three includes the actionable explanations visualization 215.

In phase one, the embodiments applied a previously trained anomaly detection VAE model to a test set with non-anomalous samples. Based on the reconstruction errors of the test samples, the embodiments defined an abnormality threshold.

In Phase two, the embodiments generate N synthetic samples obtained by walking or navigating through the latent space that exists between the embeddings of the anomalous input and the embeddings produced from the anomalous denoised sample.

In Phase three, the embodiments computed the difference between each synthetic sample Xᵢ and its immediate neighbor X₍ᵢ₊₁₎ in latent space. The embodiments use this set of differences to produce a temporal heatmap. This visualization and the counterfactual ensemble can be used to provide actionable explanations to the user because the embodiments provide the necessary changes that are made to turn an anomalous sample into a non-anomalous sample.

### Phase One: Abnormality Threshold Definition

Although variational autoencoders are unsupervised models, to use the latent space and decoder for reconstructing anomalous samples, it is desirable to train them using non-anomalous samples. With this, the disclosed model will learn to correctly reconstruct patterns considered “normal” for the analyzed domain.

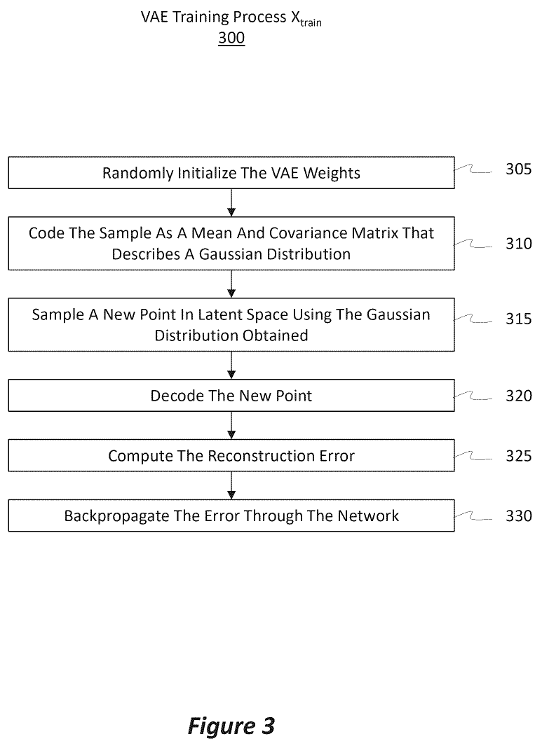

The model is trained by focusing on minimizing the reconstruction error between the decoded data and the inputs. The training process of a VAE architecture is shown in FIG. 3.

FIG. 3 shows a VAE training process 300. Process 300 includes an act (act 305) of randomly initializing the VAE weights. Acts 310 through 330 are then performed for each non-anomaly sample in Xₜᵣₐᵢₙ (or Xₜ).

In act 310, the sample is coded as a mean and covariance matrix that describes a gaussian distribution. Act 315 involves sampling a new point in latent space using the gaussian distribution obtained. Act 320 includes decoding the new point. Act 325 includes computing the reconstruction error. Act 330 includes backpropagating the error through the network.

Now, given a trained VAE model, the embodiments compute the abnormality threshold used to classify anomalies. This threshold will be calculated based on the reconstruction errors of the non-anomalous data. For this, a quantifier metric of similarity between samples can be used, such as mean squared error (MSE) or Distance Time Warping (DTW) for the specific time series case.

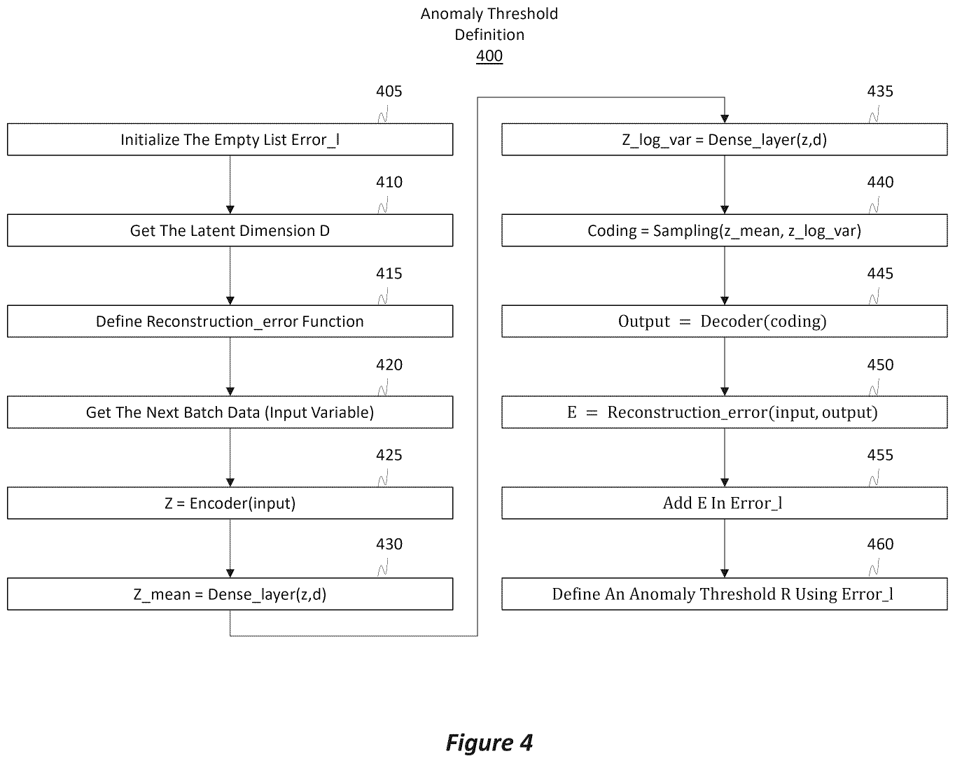

During the test step of the VAE model, for each non-anomalous sample, the embodiments compute its respective reconstruction error and store it in a list. These operations are described in FIG. 4.

FIG. 4 shows a process 400 for defining the anomaly threshold. Process 400 includes an act (act 405) of initializing the empty list error_{L}. Act 410 includes obtaining or getting the latent dimension D. Act 415 includes defining a reconstructionₑᵣᵣₒᵣ function.

Acts 420 through 455 are then performed for each testing batch. Act 420 includes obtaining or getting the next batch data (input variable). Act 425 includes an encoding process, where Z=encoder(input). Act 430 includes a mean determining process, where Zₘₑₐₙ=Dense_{layer}(Z, D). Act 435 includes the following process: Z_{log_var}=Dense_{layer}(Z, D). Act 440 includes a sampling process, where coding=Sampling(Zₘₑₐₙ, Z_{log_var}). Act 445 includes a decoding process, where output=decoder(coding). Act 450 is the following operation: e=reconstructionₑᵣᵣₒᵣ(input, output). Act 455 is the following: Add e in error_{L}. Finally, act 460 involves defining an anomaly threshold r using error_{L}.

At the end of the test, the embodiments can use the list to determine an appropriate threshold. The threshold operates as a trade-off between decreasing the False Alarm Rate (FAR) and increasing the True Positive Rate (TPR). This threshold can be defined using an expert's knowledge and statistical methods, such as computing the z-score in a normal distribution. It should be noted how the embodiments can operate in an agnostic way regarding the threshold technique applied here. That is, a z-score may be used, but another measures more appropriate to the instant use case can also be used.

### Phase Two: Actionable Explanations Generation

After the model is trained and tested for the desired anomaly detection context, the next steps consist of generating the explanations and constructing their visualizations.

The actionable explanations are computed by exploring the latent space or latent subspace that exists between the embeddings obtained by mapping the anomalous sample in the latent space and the embeddings produced by providing as input the anomalous denoised sample (e.g., output of the model when it is provided the anomalous sample as input).

Since collective anomalies are involved, the embodiments rely on the hypothesis that suspicious/malicious behavior patterns will influence the normal distribution mapping encoder, thus producing a distance between the malicious embedding and the embedding of the denoised sample. With these two points, it is possible to provide the user an explanation showing what set of changes are needed to move from the representation of the anomalous sample to the representation of its denoised sample. As the VAE provides a regular latent space, the embodiments can generate a set of synthetic samples based on sequential points taken from this space.

Given a number N, which is supplied as a hyperparameter, the embodiments can obtain N intermediary embeddings between Z_{X} (latent space embeddings) and Z_{X′} (denoised embeddings), consequently producing N new synthetic sequences. Computing the reconstruction error(s) of these N samples, it is possible to observe the generation of new samples of anomalous and non-anomalous sequences. In this way, the embodiments can divide samples into two groups, namely: Gₐₙₒₘₐₗᵢₑₛ and G_{denoised}. Considering that the input will be an anomaly, the result is the following:

If eᵢ≤r, so Xᵢ∈Gₐₙₒₘₐₗᵢₑₛ

Otherwise Xᵢ∈G_{denoised}

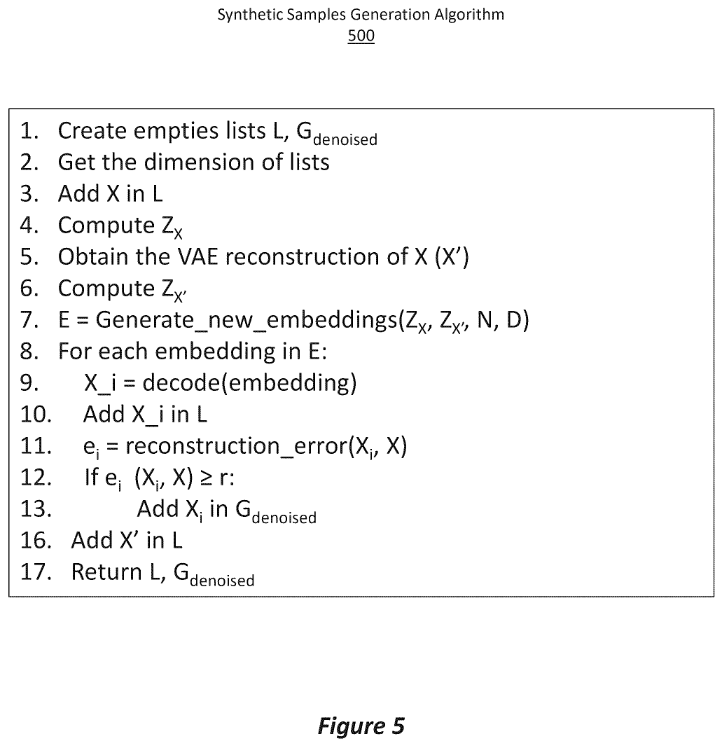

One of the objectives of the embodiments is to provide counterfactual examples. In addition to storing all of the samples produced, it is also desirable to store samples that belong to the group G_{denoised}. The details of the steps taken throughout this phase are described in the synthetic samples generation algorithm 500 of FIG. 5.

### Phase Three: Visualization Of Explanations

Based on the lists L and G_{denoised} created in phase two, the embodiments can provide two types of explanations to the users, namely: (i) the main alterations in the input that were made by the model in the denoised process and (ii) new examples of non-anomalous samples, which may be used as counterfactual examples.

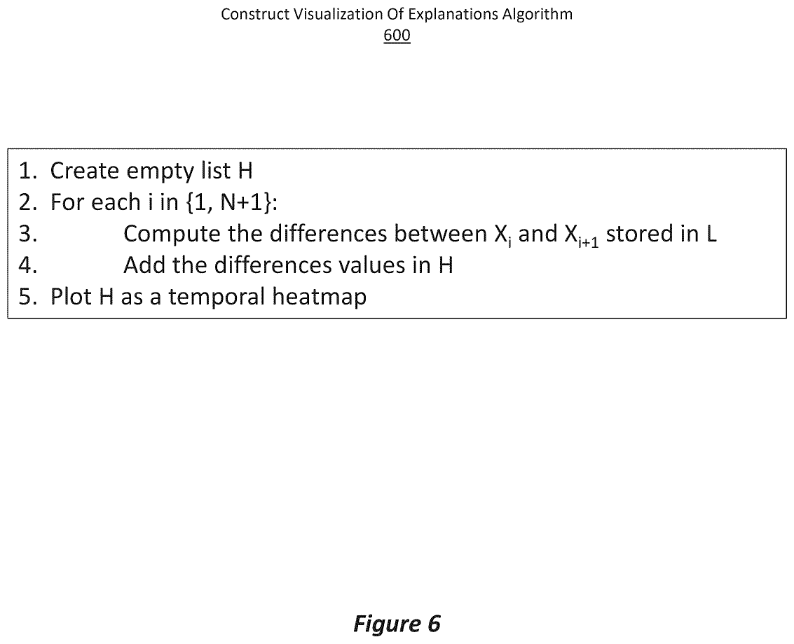

To transmit the information of (i), the embodiments can construct a heatmap that shows the main changes between the synthetic samples. With this heatmap, the embodiments can indicate to the user what changes are necessary for the model to build “good” behavior from a behavior previously characterized as anomalous. The details of how to generate this heatmap are described in the construct visualization of explanations algorithm 600 of FIG. 6.

Another explainability tool the embodiments provide is a counterfactual ensemble explanation based on the set of denoised samples collected. These synthetic samples, which correspond to the set G_{denoised}, may be used individually or as a whole, to: (i) investigate the model sensitivity in relation to the abnormality threshold (i.e., analyze examples of data present in the normality frontier learned by the model) and (ii) visualize the set of changes made in relation to the input when the embodiments navigate through the latent space generated by the model.

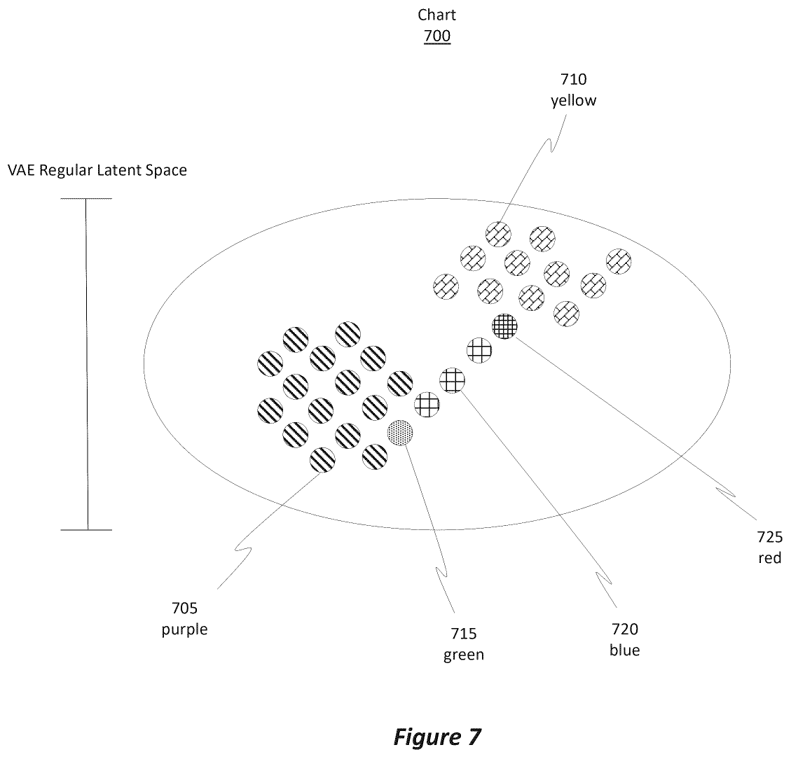

FIG. 7 shows a chart 700 depicting an illustrative example of the synthetic data generation process through the use of the VAE regular latent space. The data points styled similar to data point 705 and the data points styled similar to data point 710 represent embeddings of different data classes. Data point 705 is of the same class as data point 715. Data point 715 is an embedding that refers to a denoised sample.

Data points styled similar to data point 720 represent the synthetic embeddings. Data point 725 is an embedding that refers to an anomalous sample. The synthetic embeddings (e.g., one of which is data point 720) are generated to map the progression from the class of points corresponding to data point 710 (i.e. anomalous or “non-good” behavior) to the class of points corresponding to data point 705 (i.e. non-anomalous or “good” behavior).

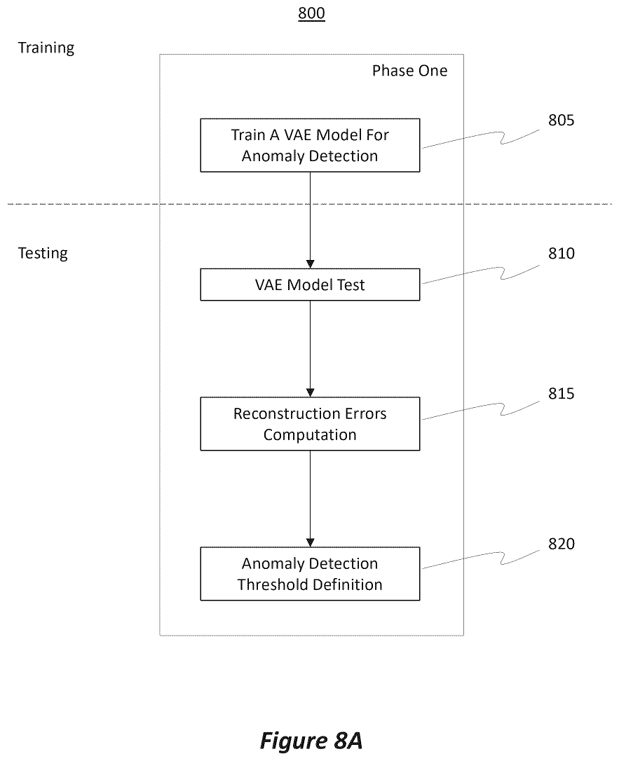

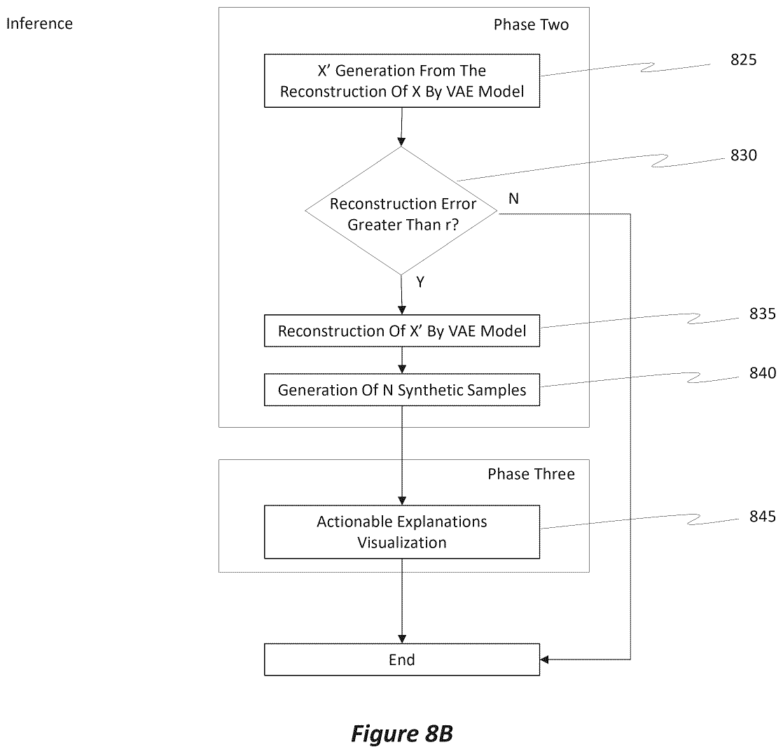

FIGS. 8A and 8B show a flowchart 800 depicting the operations of the anomaly detection model based on a VAE using the disclosed framework to generate actionable explanations. Flowchart 800 outlines three general processes, which include training, testing, and inference. Phases one, two, and three are also shown. Phase one is included in the training process and the testing process. Phases two and three are included in the inference process. Flowchart 800 includes an act (act 805) of training a VAE model for anomaly detection. Act 810 includes testing the VAE model. Act 815 includes computing reconstruction errors. Act 820 includes defining the anomaly detection threshold.

In FIG. 8B, act 825 includes generating X′ from the reconstruction of X by the VAE model. Act 830 is a decision step that determines whether the reconstruction error is greater than the value r. If not, then flowchart 800 ends. If yes, then act 835 is performed. Act 835 involves reconstructing X′ by the VAE model. Act 840 involves the generation of N synthetic samples. Act 845 includes generating the actionable explanations visualization.

Unlike sequences produced directly from the normal distribution sampling learned by the VAE, by following the disclosed techniques, the embodiments are able to obtain certain characteristics that define counterfactual examples. Once the VAE network is trained, the final explanations provided to the user have the following four characteristics and contribute to obtaining an actionable explanation.

One characteristic is validity. Here, the label of the predicted class will be changed. In other words, the embodiments receive an anomaly sequence as input and a set of non-anomalous samples will be provided as output.

Another characteristic is parsimony. Here, the synthetic samples produced by the regular latent space will be examples with minimal changes and without the observed anomalies of the original input.

Another characteristic is plausibility. With this characteristic, the VAE output will be obtained after the network training process. The acceptable patterns will be learned for the system, thus providing realistic examples for the domain in question.

The final characteristic is speed. As the embodiments remove the step of generating counterfactual samples to provide explainability by a second (post-hoc) algorithm, the embodiments will enable and provide a faster approach.

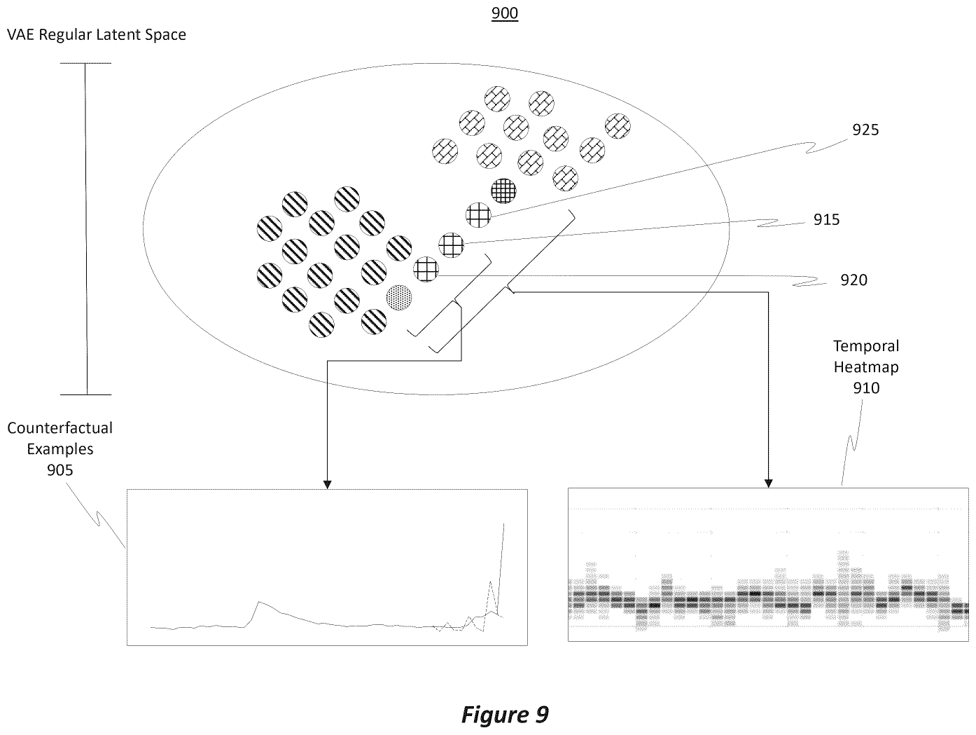

FIG. 9 illustrates an example chart 900 of the two types of explanations generated by the disclosed framework to explore the VAE regular latent space, namely, the counterfactual examples 905 and the temporal heatmap 910. Data point 915 and data point 920 correspond to synthetic non-anomalous samples, and data point 925 corresponds to a synthetic anomalous sample generated by decoding the embedding that has been produced.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

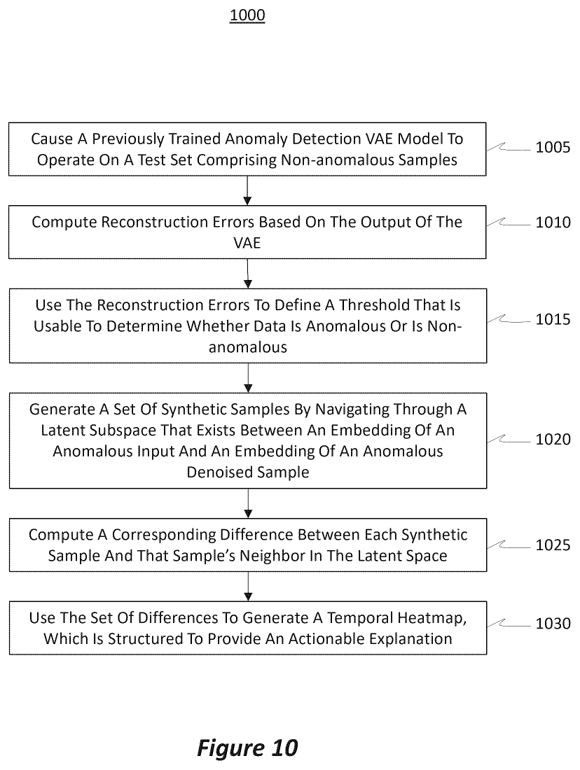

Attention will now be directed to FIG. 10, which illustrates a flowchart of an example method 1000 for extracting actionable self-explanations from variational autoencoder latent space to facilitate user and entity behavior anomaly detection. Method 1000 may be implemented within architecture 100 of FIG. 1. Method 1000 can also be implemented by service 105 of FIG. 1.

Method 1000 includes an act (act 1005) of causing a previously trained anomaly detection variational autoencoder (VAE) model to operate on a test set. This test set includes non-anomalous samples. The VAE generates an output based on its operations. In some cases, the VAE model is trained for time series reconstruction, and the VAE may be an unsupervised model. Optionally, the test set may include a set of features and timestamps.

Act 1010 includes computing reconstruction errors. These errors are computed based on the output of the VAE. The process of computing the reconstruction errors can be performed using a mean square error technique, though the reconstruction error measure applied here can be performed using any method appropriate for the instant use case (one example being mean square error). In some implementations, when the reconstruction error is above the threshold, data corresponding to the reconstruction error is considered to be anomalous. If the error is below the threshold, that data is not considered to be anomalous.

Act 1015 includes using the reconstruction errors to define a threshold. This threshold is usable to determine whether data is anomalous or is non-anomalous.

Act 1020 includes generating a set of synthetic samples. These samples are generated by navigating through a latent space that exists between an embedding of an anomalous input and an embedding of an anomalous denoised sample.

Act 1025 includes computing a corresponding difference between each synthetic sample in the set and each synthetic sample's neighbor in the latent space. The result is a set of differences. In some cases, each synthetic sample's neighbor in the latent space is an immediate neighbor.

Act 1030 includes using the set of differences to generate a temporal heatmap. This temporal heatmap is structured to provide an actionable explanation, which details what changes are made to turn an anomalous sample into a non-anomalous sample.

In some implementations, method 1000 further includes an act of generating counterfactual ensembles. Optionally, the counterfactual ensembles highlight possible actionable changes that can be made to turn the anomalous sample into the non-anomalous sample.

### Example Computer Systems

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general-purpose computer, special purpose computer, or special purpose processing device to perform a certain function or group of functions. As such, some embodiments of the invention may be downloadable to one or more systems or devices, for example, from a website, mesh topology, or other source. Also, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, client, engine, agent, services, and component are examples of terms that may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

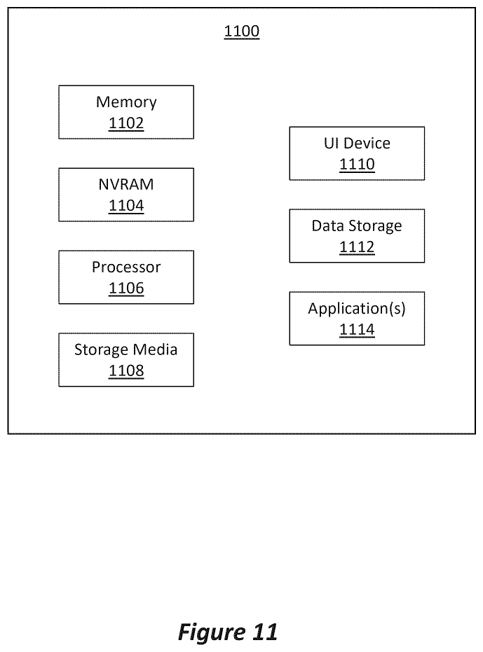

With reference briefly now to FIG. 11, any one or more of the entities disclosed, or implied, by the Figures and/or elsewhere herein, may take the form of, or include, or be implemented on, or hosted by, a physical computing device, one example of which is denoted at 1100. Also, where any of the aforementioned elements comprise or consist of a virtual machine (VM), that VM may constitute a virtualization of any combination of the physical components disclosed in FIG. 11.

In the example of FIG. 11, the physical computing device 1100 includes a memory 1102 which may include one, some, or all, of random access memory (RAM), non-volatile memory (NVM) 1104 such as NVRAM for example, read-only memory (ROM), and persistent memory, one or more hardware processors 1106, non-transitory storage media 1108, UI device 1110, and data storage 1112. One or more of the memory 1102 of the physical computing device 1100 may take the form of solid-state device (SSD) storage. Also, one or more applications 1114 may be provided that comprise instructions executable by one or more hardware processors 1106 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The physical device 1100 may also be representative of an edge system, a cloud-based system, a datacenter or portion thereof, or other system or entity.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
causing a previously trained anomaly detection variational autoencoder (VAE) model to operate on a test set comprising non-anomalous samples, the VAE generating an output based on said operating;
computing reconstruction errors based on the output of the VAE;
using the reconstruction errors to define a threshold that is usable to determine whether data is anomalous or is non-anomalous;
generating a set of synthetic samples by navigating through a latent space that exists between an embedding of an anomalous input and an embedding of an anomalous denoised sample;
computing a corresponding difference between each synthetic sample in the set of synthetic samples and said each synthetic sample's neighbor in the latent space, resulting in generation of a set of differences; and
using the set of differences to generate a temporal heatmap, wherein the temporal heatmap is structured to provide an actionable explanation, which details what changes are made to turn an anomalous sample into a non-anomalous sample.

2. The method of claim 1, wherein said each synthetic sample's neighbor in the latent space is an immediate neighbor.

3. The method of claim 1, wherein said method further includes generating counterfactual ensembles.

4. The method of claim 3, wherein the counterfactual ensembles highlight possible actionable changes that can be made to turn the anomalous sample into the non-anomalous sample.

5. The method of claim 1, wherein the previously trained anomaly detection VAE model is trained for time series reconstruction.

6. The method of claim 1, wherein the test set includes a set of features and timestamps.

7. The method of claim 1, wherein computing the reconstruction errors is performed using a mean square error technique.

8. The method of claim 1, wherein, when the reconstruction error is above the threshold, data corresponding to the reconstruction error is considered to be anomalous.

9. The method of claim 1, wherein the previously trained anomaly detection VAE model is an unsupervised model.

10. A computer system comprising:
one or more processors; and
one or more hardware storage devices that store instructions that are executable by the one or more processors to cause the computer system to:
cause a previously trained anomaly detection variational autoencoder (VAE) model to operate on a test set comprising non-anomalous samples, the VAE generating an output based on said operating;
compute reconstruction errors based on the output of the VAE;
use the reconstruction errors to define a threshold that is usable to determine whether data is anomalous or is non-anomalous;
generate a set of synthetic samples by navigating through a latent space that exists between an embedding of an anomalous input and an embedding of an anomalous denoised sample;
compute a corresponding difference between each synthetic sample in the set of synthetic samples and said each synthetic sample's neighbor in the latent space, resulting in generation of a set of differences; and
use the set of differences to generate a temporal heatmap, wherein the temporal heatmap is structured to provide an actionable explanation, which details what changes are made to turn an anomalous sample into a non-anomalous sample.

11. The computer system of claim 10, wherein weights of the previously trained anomaly detection VAE model are randomly initialized.

12. The computer system of claim 10, wherein the reconstruction errors are backpropagated through a network of the previously trained anomaly detection VAE model.

13. The computer system of claim 10, wherein the threshold operates as a trade-off between a decrease to a false alarm rate and an increase to a true positive rate.

14. The computer system of claim 10, wherein the threshold is defined using a z-score in a normal distribution.

15. The computer system of claim 10, wherein said each synthetic sample's neighbor in the latent space is an immediate neighbor.

16. The computer system of claim 10, wherein the previously trained anomaly detection VAE model is trained for time series reconstruction.

17. The computer system of claim 10, wherein the test set includes a set of features and timestamps.

18. A computer system comprising:
one or more processors; and
one or more hardware storage devices that store instructions that are executable by the one or more processors to cause the computer system to:
cause a previously trained anomaly detection variational autoencoder (VAE) model to operate on a test set comprising non-anomalous samples, the VAE generating an output based on said operating;
compute reconstruction errors based on the output of the VAE;
use the reconstruction errors to define a threshold that is usable to determine whether data is anomalous or is non-anomalous;
generate a set of synthetic samples by navigating through a latent space that exists between an embedding of an anomalous input and an embedding of an anomalous denoised sample;
compute a corresponding difference between each synthetic sample in the set of synthetic samples and said each synthetic sample's immediate neighbor in the latent space, resulting in generation of a set of differences; and
use the set of differences to generate a temporal heatmap, wherein the temporal heatmap is structured to provide an actionable explanation, which details what changes are made to turn an anomalous sample into a non-anomalous sample.

19. The computer system of claim 18, wherein the previously trained anomaly detection VAE model is trained for time series reconstruction.

20. The computer system of claim 18, wherein the previously trained anomaly detection VAE model is an unsupervised model.
